(19) United States
(12) Patent Application Publication
(10) Pub. No.: US 2013/0106952 A1
(43) Pub. Date: May 2, 2013

(54) MAINTENANCE UNIT HAVING A PLURALITY OF WIPERS, AND INK-JET RECORDING APPARATUS

(71) Applicant: KYOCERA DOCUMENT SOLUTIONS INC., Osaka (JP)

(72) Inventor: Kikunosuke Tsuji, Osaka (JP)

(73) Assignee: KYOCERA DOCUMENT SOLUTIONS INC., Osaka (JP)

(21) Appl. No.: 13/660,171

(22) Filed: Oct. 25, 2012

(30) Foreign Application Priority Data
Oct. 27, 2011 (JP) 2011-235593

(51) Int. Cl. B41J 2/165

(52) U.S. Cl. 347/33

(57) ABSTRACT

A maintenance unit used in an ink-jet recording apparatus including a plurality of recording heads having ink ejection surfaces includes a plurality of wipers, a carriage, a support frame, a drive mechanism, and a lifting and lowering mechanism. The plurality of wipers may be positioned so as to correspond to the plurality of recording heads, and are configured to wipe ink ejection surfaces of the plurality of recording heads. The drive mechanism is configured to reciprocate the carriage along the support frame. The lifting and lowering mechanism is configured to lift and lower the support frame together with the carriage toward and away from the ink ejection surfaces. By reciprocating and lifting and lowering the plurality of wipers, the ink ejection surfaces of the plurality of recording heads may be wiped by the plurality of wipers. The maintenance unit may be used in an ink-jet recording apparatus.

### INCORPORATION BY REFERENCE

This application is based upon, and claims the benefit of priority from, corresponding Japanese Patent Application No. 2011-235593 filed in the Japan Patent Office on Oct. 27, 2011, the entire contents of each which are incorporated herein by reference.

### BACKGROUND

The present disclosure relates to an ink-jet recording apparatus that performs recording by ejecting ink onto a recording medium such as paper. The present disclosure also relates to the driving of a wiping mechanism that cleans the ink ejection surface of a recording head.

Recording apparatuses such as fax machines, copying machines, and printers are designed to record an image on a recording medium such as paper or an OHP sheet. The methods these recording apparatuses use include ink-jet methods, wire-dot methods, and thermal methods. Ink-jet recording methods include a serial-type method and a line-head-type method. In the serial-type ink-jet recording method, a recording head performs recording while scanning a recording medium. In the line-head-type ink-jet recording method, recording is performed by a single pass method (one pass method). In an ink-jet recording apparatus using the line-head-type ink-jet recording method, a linear recording head is fixed to the apparatus main body.

A line-head-type ink-jet recording apparatus uses line-head-type ink-jet heads (recording heads) for respective colors. In each head, ejection nozzles are positioned at predetermined intervals throughout the length of the printing region in the direction perpendicular to the recording medium transport direction. By ejecting ink from ejection nozzles corresponding to the printing position as the recording medium is transported, printing is performed on the entire recording medium.

In such a line-head-type ink-jet recording apparatus, ink is ejected from ink ejection nozzles whose openings are provided in the ink ejection surfaces of the recording heads, and then ink attached to the ink ejection surfaces is wiped to recover the recording heads. Thus, drying of ink in the nozzles and clogging of the nozzles can be prevented.

For example, a liquid ejecting apparatus used as an ink-jet recording apparatus includes a plurality of recording heads (liquid ejecting heads) positioned along the recording medium transport direction, a plurality of wipers that wipe the ink ejection surfaces of the recording heads, a holding member that holds the plurality of wipers, and a moving mechanism that moves the holding member in the direction perpendicular to the recording medium transport direction. In this apparatus, for example, by providing engaging members that enter the gaps between the recording heads when the holding member is moved, the holding member is prevented from moving in a direction oblique to the recording heads, and the recording heads for respective colors can be wiped at the same time, while maintaining the positional relationship between the wipers and the ejection surfaces.

### SUMMARY

According to an embodiment of the present disclosure, a maintenance unit is provided that is used in an ink-jet recording apparatus including a plurality of recording heads having ink ejection surfaces includes a plurality of wipers, a carriage, a support frame, a drive mechanism, and a lifting and lowering mechanism. The plurality of wipers may be positioned so as to correspond to the plurality of recording heads, and are configured to wipe ink ejection surfaces of the plurality of recording heads. The plurality of wipers may be fixed to the carriage. The support frame may support the carriage such that the carriage can reciprocate. The drive mechanism is configured to reciprocate the carriage along the support frame. The lifting and lowering mechanism is configured to lift and lower the support frame together with the carriage toward and away from the ink-ejection surfaces. By reciprocating and lifting and lowering the plurality of wipers, the ink ejection surfaces of the plurality of recording heads may be wiped by the plurality of wipers.

According to another embodiment of the present disclosure, an ink-jet recording apparatus is provided that includes a recording medium transport mechanism, a recording portion, and the maintenance unit having the above-described configuration. The recording medium transport mechanism is configured to transport a recording medium in a first direction. The recording portion includes one or more line heads that are positioned along the first direction and in each of which a plurality of recording heads may be positioned in a second direction perpendicular to the first direction. The plurality of recording heads are configured to eject ink onto the recording medium transported by the recording medium transport mechanism.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 is a side view schematically showing an outline of the configuration of an ink-jet recording apparatus according to an embodiment of the present disclosure;

FIG. 2 is a top plan view of a first transport unit and a recording portion of the ink-jet recording apparatus shown in FIG. 1;

FIG. 3 is a top perspective view of the recording portion;

FIG. 4 is a diagram schematically showing an ink flow path from an ink tank to the recording heads of the ink-jet recording apparatus of the present disclosure;

FIG. 5 is a top perspective view of a wiping mechanism mounted in a maintenance unit;

FIG. 6 is a top perspective view of a carriage including the wiping mechanism;

FIG. 7 is a top perspective view of a support frame including the wiping mechanism;

FIG. 8 is a perspective view showing the wiping mechanism removed from a unit housing of the maintenance unit;

FIG. 9 is a perspective view of lifting and lowering mechanisms positioned in the unit housing, and shows the lift members in a horizontal state;

FIG. 10 is a perspective view of the lifting and lowering mechanisms positioned in the unit housing, and shows the lift members in an upright state;

FIG. 11 is a perspective view of one of the lift members including one of the lifting and lowering mechanisms;

FIG. 12 is a side view showing the maintenance unit positioned under the recording portion;

FIG. 13 is a side view showing the carriage, wipers, support frame, and lifting and lowering mechanisms in the maintenance unit in the position illustrated in FIG. 12;

FIG. 14 is a side view showing the support frame and the carriage raised from the position illustrated in FIG. 13 by the lifting and lowering mechanisms, and the wipers pressed against ink ejection surfaces;

FIG. 15 is a side view showing the carriage moved from the position illustrated in FIG. 14 in the wiping direction (direction of arrow A);

FIG. 16 is a side view showing the support frame and the carriage lowered from the position illustrated in FIG. 15 by the lifting and lowering mechanisms, and the wipers are away from the ink ejection surfaces; and

FIG. 17 is a side view showing the carriage moved from the position illustrated in FIG. 16 in the direction opposite to the wiping direction (direction of arrow A′).

### DETAILED DESCRIPTION

Example apparatus and unit are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

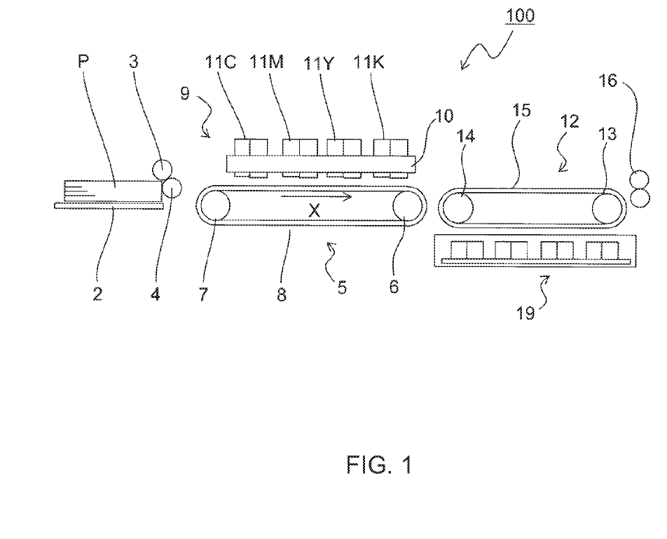

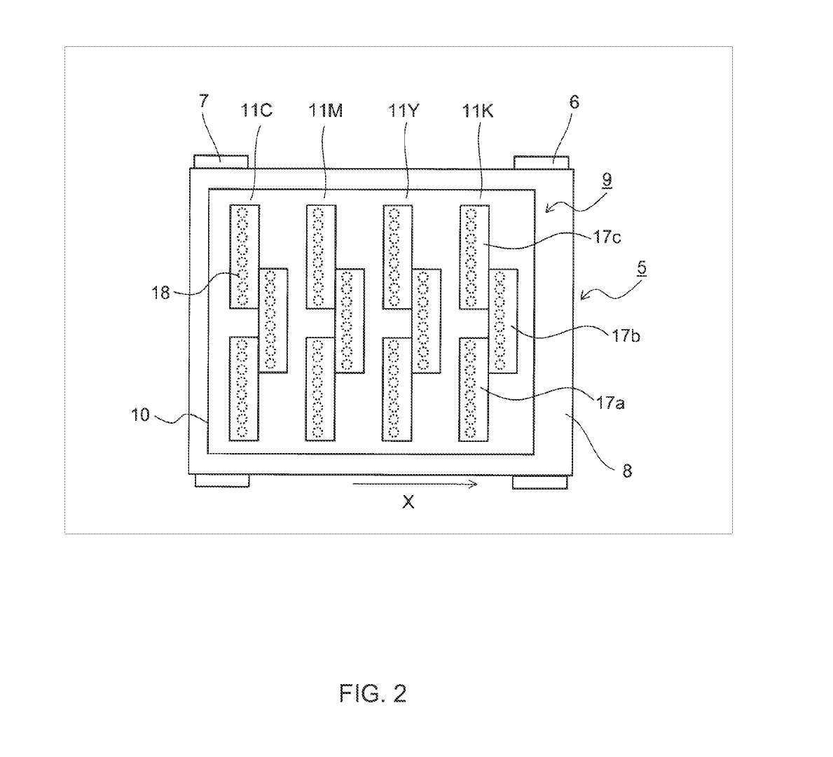

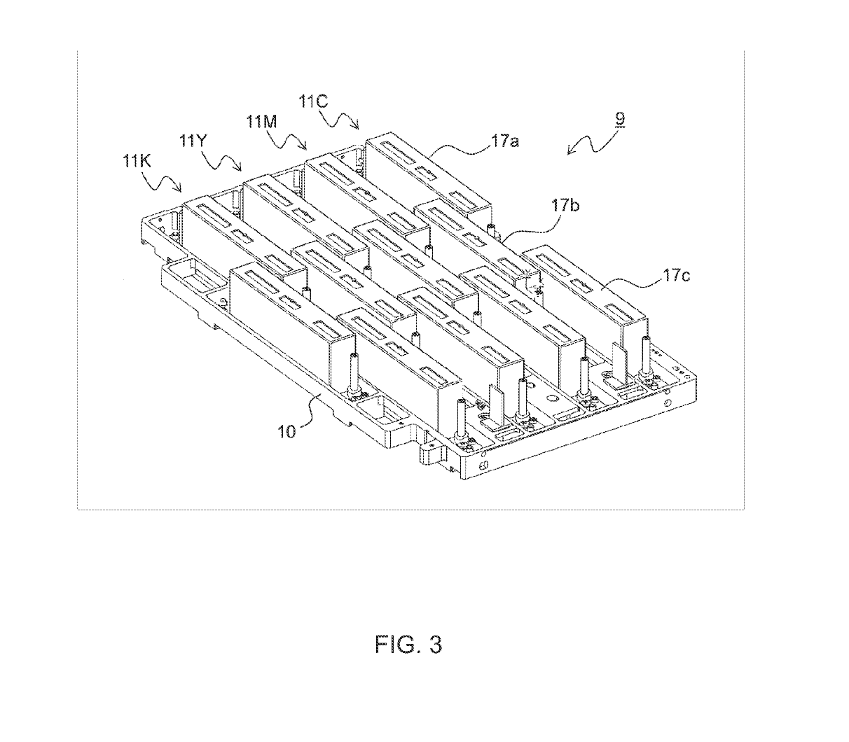

An embodiment of the present disclosure will be described with reference to the drawings. FIG. 1 is a side view schematically showing an outline of the configuration of an ink-jet recording apparatus 100. FIG. 2 is a top plan view of a first transport unit 5 (recording medium transport mechanism) and a recording portion 9 of the ink-jet recording apparatus 100 shown in FIG. 1. FIG. 3 is a top perspective view of the recording portion 9. FIG. 3 shows the recording portion 9 viewed from the back of FIG. 1 (that is, from the top of FIG. 2). In FIG. 3, line heads 11C to 11K are arranged in the reverse order to that shown in FIG. 1 and FIG. 2.

As shown in FIG. 1, a paper feed tray 2 that stores sheets P of paper is provided in the left part of the ink-jet recording apparatus 100. A paper feed roller 3 and a driven roller 4 are provided at one end of the paper feed tray 2. The paper feed roller 3 transports and feeds the stored sheets P one at a time in the order from the uppermost sheet P to a first transport unit 5 described below. The driven roller 4 is pressed against the paper feed roller 3 and is rotationally driven.

A first transport unit 5 and a recording portion 9 are disposed on the downstream side (the right side in FIG. 1) of the paper feed roller 3 and the driven roller 4 in the sheet transport direction (the direction of arrow X). The first transport unit 5 includes a first drive roller 6 located on the downstream side in the sheet transport direction, a first driven roller 7 located on the upstream side, and a first transport belt 8 looped over the first drive roller 6 and the first driven roller 7. By rotationally driving the first drive roller 6 in the clockwise direction, a sheet P held by the first transport belt 8 is transported in the direction of arrow X.

Since the first drive roller 6 is disposed on the downstream side in the sheet transport direction, the transport surface (the upper surface in FIG. 1) of the first transport belt 8 is pulled by the first drive roller 6. Therefore, the tension of the transport surface of the first transport belt 8 can be increased, and the sheet P can be stably transported. The first transport belt 8 may be made of a dielectric resin sheet. A belt having no seams (seamless belt) may be used as the first transport belt 8.

The recording portion 9 has line heads 11C, 11M, 11Y, and 11K. The line heads 11C, 11M, 11Y, and 11K may be held, for example, by a head housing 10. The line heads 11C to 11K are supported at a predetermined distance (for example, 1 mm) from the transport surface of the first transport belt 8. As shown in FIG. 2, a plurality of (three, here) recording heads 17a to 17c are positioned in a staggered manner along the paper width direction (the vertical direction in FIG. 2) perpendicular to the sheet transport direction. The line heads 11C to 11K each have a recording region having a width equal to or larger than the width of the transported sheet P. The line heads 11C to 11K are configured to eject ink onto the sheet P transported on the first transport belt 8, from ink ejection nozzles 18 corresponding to the printing position. The recording heads 17a to 17c are positioned such that some of the plurality of ink ejection nozzles 18 provided in each of the recording heads 17a to 17c overlap in the sheet transport direction.

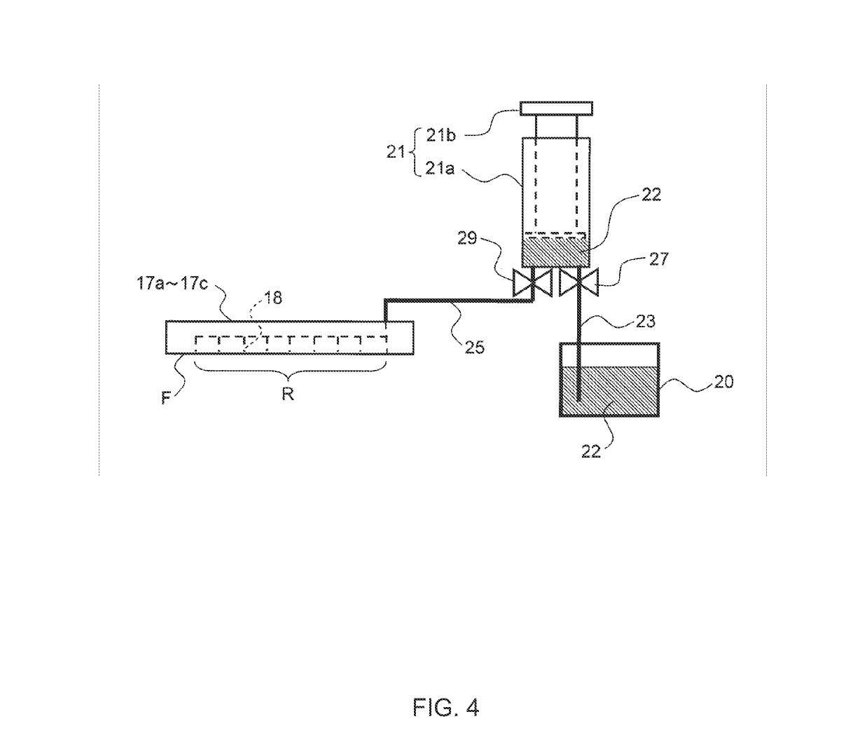

The recording heads 17a to 17c constituting the line heads 11C, 11M, 11Y, and 11K are supplied with cyan, magenta, yellow, and black inks, respectively, stored in an ink tank 20 (see FIG. 4).

The recording heads 17a to 17c eject ink from the ink ejection nozzles 18 toward the sheet P attracted to and held and transported by the transport surface of the first transport belt 8, according to image data received from an external computer or the like. Thus, a color image in which four colors (cyan, magenta, yellow, and black) of ink are overlapped is formed on the sheet P on the first transport belt 8.

In order to prevent a defective ejection of ink due to the drying or clogging of the recording heads 17a to 17c, when printing is started after a long interval, ejection of thickened ink in the nozzles, referred to as purge, may be performed from the ink ejection nozzles 18 of all of the recording heads 17a to 17c to prepare for the next printing operation. Between printing operations, the purge may be performed from the ink ejection nozzles 18 of the recording heads 17a to 17c in which the amount of ink ejection is equal to or less than a specified value, to prepare for the next printing operation.

Various methods, such as a piezoelectric method and a thermal ink-jet method, can be used to eject ink from the recording heads 17a to 17c. The piezoelectric method employs a piezoelectric element (not shown) to force out ink. In the thermal ink-jet method, a heating element generates a bubble, which applies a pressure to ink, thereby ejecting ink.

A second transport unit 12 is positioned on the downstream side (the right side in FIG. 1) of the first transport unit 5 in the sheet transport direction. The second transport unit 12 includes a second drive roller 13 positioned on the downstream side in the sheet transport direction, a second driven roller 14 positioned on the upstream side, and a second transport belt 15 looped over the second drive roller 13 and the second driven roller 14. By rotationally driving the second drive roller 13 in the clockwise direction, a sheet P held by the second transport belt 15 is transported in the sheet transport direction of arrow X.

The sheet P on which an ink image is recorded in the recording portion 9 is sent to the second transport unit 12. While the sheet P passes through the second transport unit 12, the ink ejected onto the surface of the sheet P is dried. A maintenance unit 19 is located under the second transport unit 12. When the purge is performed, the maintenance unit 19 moves to a position under the recording portion 9. The maintenance unit 19 is configured so as to be able to be located in a maintenance position where the maintenance unit 19 is close to the ink ejection surfaces (the ink ejection surfaces F described later) of the plurality of recording heads 17a to 17c of the recording portion 9, and a retracted position where the maintenance unit 19 is retracted from the ink ejection surfaces F. The maintenance unit 19 wipes the ink ejected from the ink ejection nozzles 18 of the recording heads 17 by the purge operation, and collects the wiped ink. The detailed configuration of the maintenance unit 19 will be described later.

An eject roller pair 16 that ejects a sheet P on which an image is recorded to the outside of the apparatus main body is positioned on the downstream side of the second transport unit 12 in the sheet transport direction. An eject tray (not shown) on which sheets P ejected to the outside of the apparatus main body are loaded is positioned on the downstream side of the eject roller pair 16.

Next, the supply of ink from the ink tank 20 to the recording heads 17a to 17c during printing, and the ejection of ink from the recording heads 17a to 17c during the purge will be described. FIG. 4 is a diagram schematically showing an ink flow path from the ink tank 20 to the recording heads 17a to 17c of the ink-jet recording apparatus 100. Although the ink flow path shown in FIG. 4 is provided for each color, between the ink tank 20 and the recording heads 17a to 17c, the ink flow path for any one of the colors will be described here.

As shown in FIG. 4, a syringe pump 21 is located between the ink tank 20 and the recording heads 17a to 17c. The ink tank 20 and the syringe pump 21 are connected by a first supply path 23 constituted by a tube member. The syringe pump 21 and the ink ejection nozzles 18 in the recording heads 17a to 17c are connected by a second supply path 25 constituted by a tube member.

The first supply path 23 is provided with an inflow valve 27. The second supply path 25 is provided with an outflow valve 29. By opening and closing the inflow valve 27, the movement of ink in the first supply path 23 is allowed or restricted. By opening and closing the outflow valve 29, the movement of ink in the second supply path 25 is allowed or restricted.

The syringe pump 21 has a cylinder 21a and a piston 21b. The cylinder 21a is connected to the first supply path 23 and the second supply path 25. Ink 22 in the ink tank 20 flows through the first supply path 23 into the cylinder 21a. Ink is discharged from the cylinder 21a through the second supply path 25. Discharged ink is supplied to the recording heads 17a to 17c. Supplied ink is ejected from the ink ejection nozzles 18 to the nozzle region R of the ink ejection surface F.

The piston 21b can be moved up and down by a drive device (not shown). A seal (not shown) such as an O-ring is attached to the outer circumference of the piston 21b. By using the seal, leakage of ink from the cylinder 21a is prevented. In addition, due to the seal, the piston 21b can slide smoothly along the inner peripheral surface of the cylinder 21a.

During normal time (during printing), as shown in FIG. 4, the inflow valve 27 and the outflow valve 29 are both open. By holding the piston 21b at a predetermined position, the cylinder 21a is filled with a substantially constant amount of ink. Due to surface tension (meniscus) between the cylinder 21a and the recording heads 17a to 17c, ink is supplied from the cylinder 21a to the recording heads 17a to 17c.

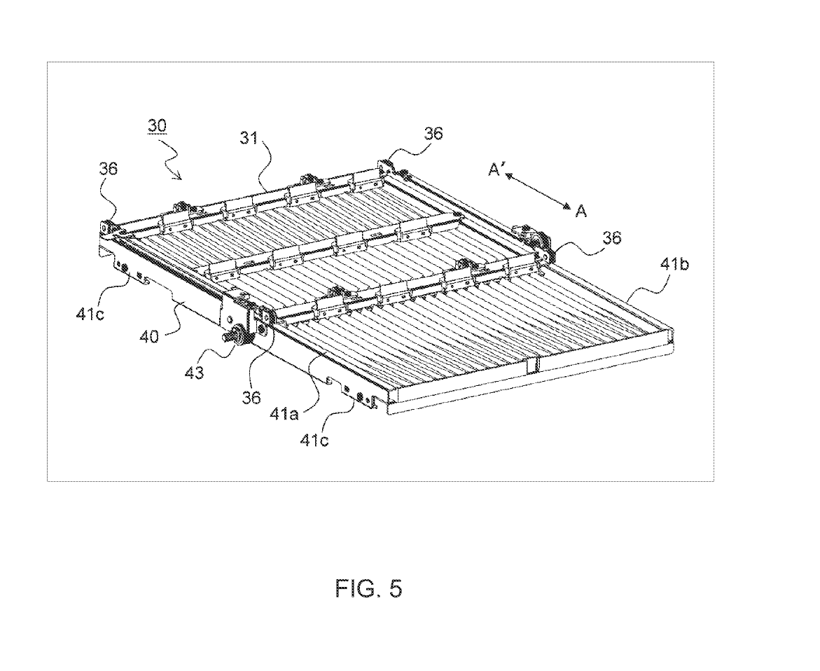

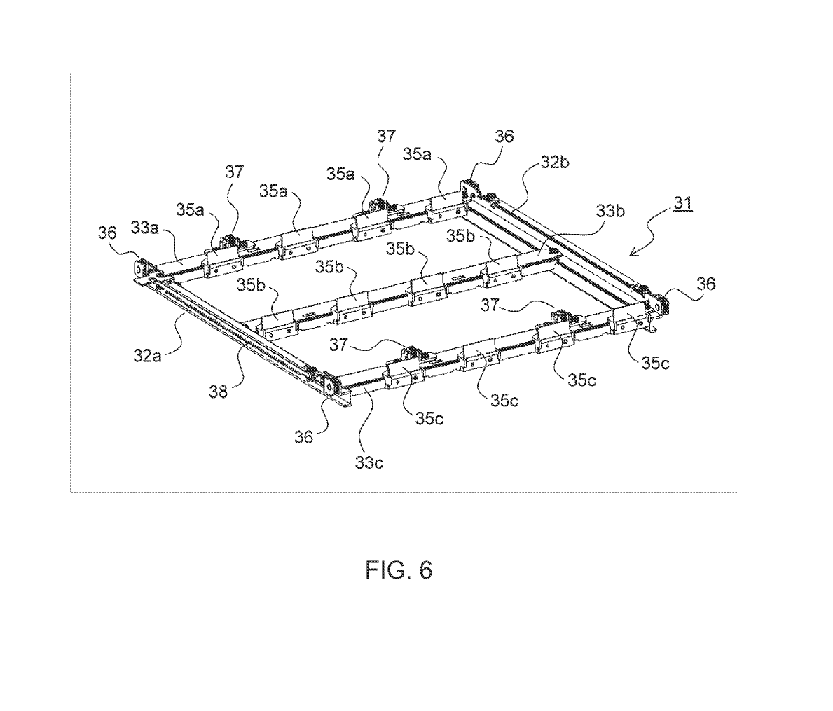

FIG. 5 is a perspective view of a wiping mechanism 30 mounted in the maintenance unit 19. The wiping mechanism 30 includes a substantially rectangular carriage 31 to which a plurality of wipers 35a to 35c (see FIG. 6) are fixed, and a support frame 40 that supports the carriage 31. Rail portions 41a and 41b are formed on two opposed edges of the upper surface of the support frame 40. Sliding rollers 36 provided at the four corners of the carriage 31 are in contact with the rail portions 41a and 41b. Owing to this configuration, the carriage 31 is slidably supported in the direction of arrow AA′ relative to the support frame 40.

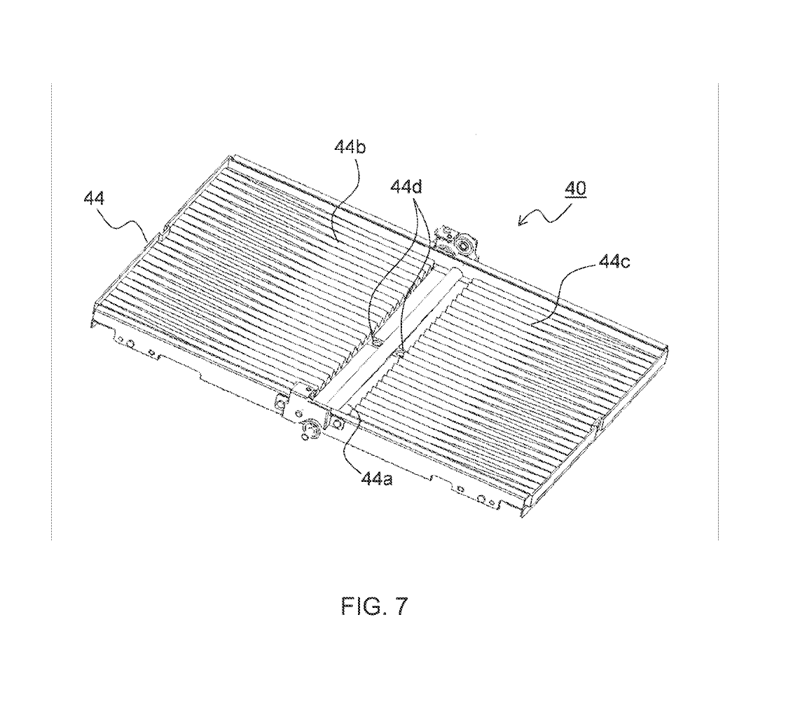

FIG. 6 is a perspective view of the carriage 31 including the wiping mechanism 30. FIG. 7 is a perspective view of the support frame 40 including the wiping mechanism 30. As shown in FIG. 6, the carriage 31 is formed in a frame-like shape by first stays 32a and 32b that slidably engage with the rail portions 41a and 41b of the support frame 40, and second stays 33a, 33b, and 33c fixed like bridges between the first stays 32a and 32b. The support frame 40 is rectangular as shown in FIGS. 5 and 7. The support frame 40 has a rectangular shape having two sides extending parallel to the recording medium transport direction, and two sides extending parallel to the direction perpendicular to the recording medium transport direction.

The first stay 32a has a rack 38 that meshes with an input gear 43 (see FIG. 5) held by the support frame 40. When the input gear 43 rotates forward and backward, the carriage 31 reciprocates along the support frame 40 in a horizontal direction (the direction of arrow AA′ in FIG. 5). That is, drive mechanism of the carriage 31 includes the input gear 43 and is configured to reciprocate the carriage 31 along the support frame 40.

The wipers 35a to 35c are configured to wipe ink ejected from the ink ejection nozzles 18 of the recording heads 17a to 17c. In this embodiment, when the wipers 35a to 35c perform a wiping operation, the wipers 35a to 35c are each pressed substantially perpendicularly against a wiping start position outside the nozzle region R (see FIG. 4) where the nozzle surfaces of the ink ejection nozzles 18 are exposed. Due to movement of the carriage 31, the ink ejection surface F including the nozzle region R is wiped in a predetermined direction (the direction of arrow A in FIG. 5). In this embodiment, the plurality of wipers 35a to 35c are configured so as to be able to be located in a wiping position where they are close to the ink ejection surface F and can perform the wiping operation; and an away position where they are away from the ink ejection surface F when the maintenance unit 19 is in the maintenance position.

Four wipers 35a are fixed to the second stay 33a at substantially regular intervals. Similarly, four wipers 35b are fixed to the second stay 33b at substantially regular intervals, and tour wipers 35c are fixed to the second stay 33c at substantially regular intervals. The wipers 35a and 35c are located at positions corresponding to the left and right recording heads 17a and 17c (see FIG. 3) of the line heads 11C to 11K. The wipers 35b are located at positions corresponding to the central recording heads 17b (see FIG. 3) of the line heads 11C to 11K. The wipers 35b are offset from the wipers 35a and 35c by a predetermined distance in the direction perpendicular to the moving direction of the carriage 31 (the direction of arrow AA′ in FIG. 5).

For example, gap rollers 37 may be positioned at four places in the upper surface of the second stays 33a and 33c. When the wiping mechanism 30 is raised toward the recording portion 9 in order for the wipers 35a to 35c to wipe the ink ejection surfaces F of the recording heads 17a to 17c, the gap rollers 37 come into contact with the head housing 10 of the recording portion 9, thereby maintaining a constant contact state between the wipers 35a to 35c and the ink ejection surfaces F. That is to say, the gap rollers 37 maintain a constant distance between the wipers 35a to 35c and the ink ejection surfaces F in the contact state between the wipers 35a to 35c and the ink ejection surfaces F. For example, while the wiping operation is performed, a constant distance is maintained between the wipers 35a to 35c and the ink ejection surfaces F.

For example, flexible members formed of an elastic material are used as the wipers 35a to 35c; rubber blades can be used as the wipers 35a to 35c. The wipers 35a to 35c are configured such that when the wipers 35a to 35c are performing the wiping operation, the distal ends of the wipers 35a to 35c are in contact with the ink ejection surfaces F and the wipers 35a to 35c are bent. If the distance from the places in the carriage 31 where the wipers 35a to 35c are provided (for example, the upper surfaces of the second stays 33a to 33c) to the distal ends of the wipers 35a to 35c before being bent is denoted as Lp (mm), the distance from the carriage 31 to the ink ejection surfaces F after the wipers 35a to 35c are bent may be set, for example, to Lp−0.5 (mm). In this case, the amount of protrusion of the wipers 35a to 35c relative to the ink ejection surfaces F is set to about 0.5 mm. As described above, during the wiping operation, a constant amount of bending of the wipers 35a to 35c relative to the ink ejection surfaces F is maintained by the gap rollers 37. As described above, a constant distance between the wipers 35a to 35c and the ink ejection surfaces F is maintained in the contact state between the wipers 35a to 35c and the ink ejection surfaces F. That is to say, while the wiping operation is performed, a constant distance is maintained between the wipers 35a to 35c and the ink ejection surfaces F. Thus, a constant contact state of the wipers 35a to 35c relative to the ink ejection surfaces F is maintained during the wiping operation. The amount of bending of the wipers 35a to 35c (that is, the amount of protrusion of the wipers 35a to 35c relative to the ink ejection surfaces F) may be set to a value other than 0.5 mm, and may be set in view of, for example, the flexibility and wiping performance of the wipers 35a to 35c.

As shown in FIG. 7, an ink collecting tray 44 may be positioned on the upper surface of the support frame 40. The ink collecting tray 44 collects wasted ink wiped from the ink ejection surfaces F by the wipers 35a to 35c. In the substantially central part of the ink collecting tray 44, a groove portion 44a is formed along the direction in which the second stays 33a to 33c extend. The tray surfaces 44b and '44c on both sides of the groove portion 44a are inclined downwardly toward the groove portion 44a. Ink discharge holes 44d are provided in the groove portion 44a. The bottom surface of the groove portion 44a is inclined downwardly toward the ink discharge holes 44d.

Wasted ink that is wiped from the ink ejection surfaces F and falls to the tray surfaces 44b and 44c is collected in the groove portion 44a. The collected ink flows through the groove portion 44a toward the ink discharge holes 44d. The ink then passes through an ink collecting path (not shown) connected to the ink discharge holes 44d and is collected in a wasted ink collecting tank (not shown).

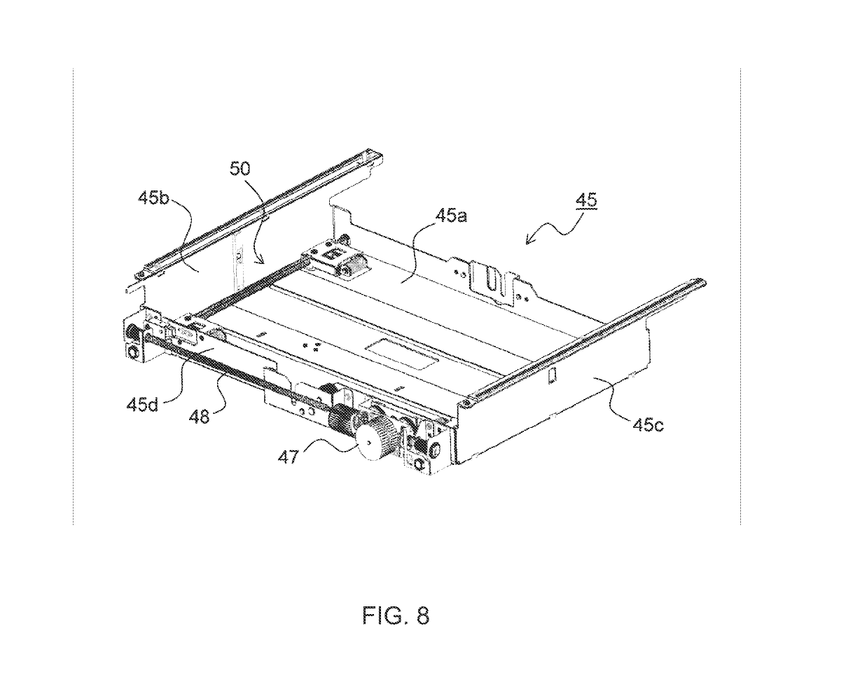

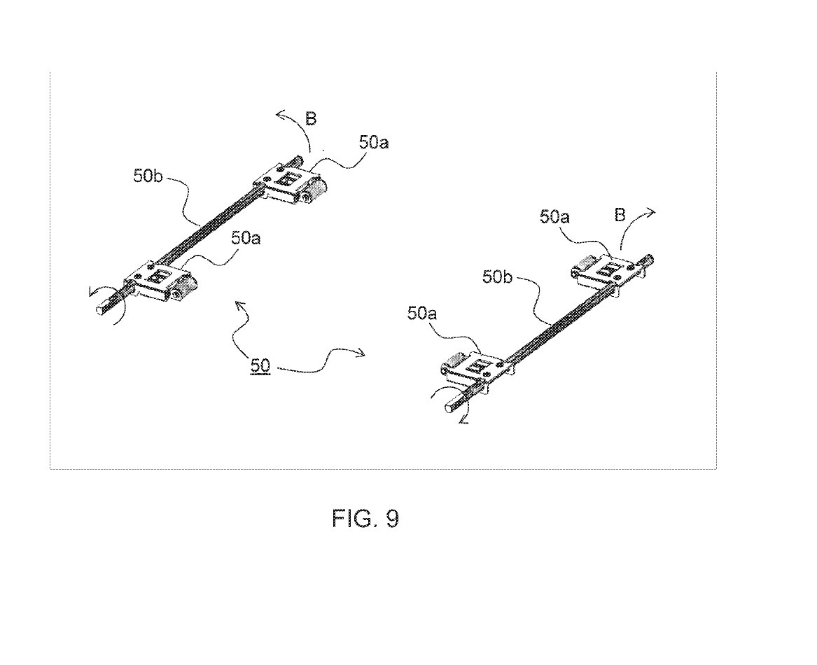

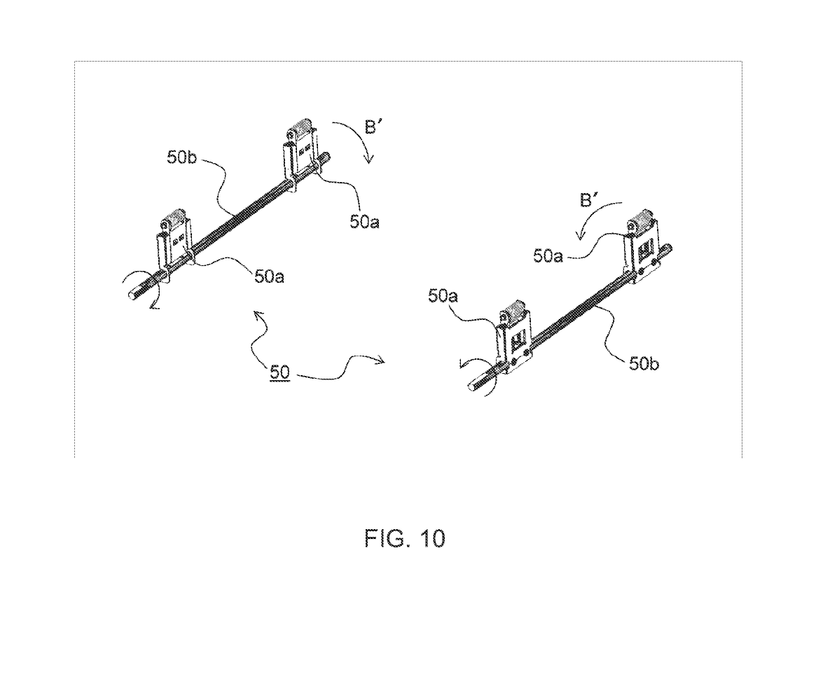

Next, the lifting and lowering mechanisms 50 of the wiping mechanism 30 will be described. FIG. 8 is a perspective view showing the wiping mechanism 30 removed from a unit housing 45 of the maintenance unit 19. FIG. 9 and FIG. 10 are perspective views of the lifting and lowering mechanisms 50 disposed in the unit housing 45. The lifting and lowering mechanisms 50 have a plurality of lift members 50a and a plurality of shafts 50b. The lifting and lowering mechanisms 50 are a pair of lifting and lowering mechanisms 50 each having two lift members 50a fixed to both ends of a shaft 50b. The lifting and lowering mechanisms 50 are located on the bottom surface 45a of the unit housing 45 and along side surfaces 45b and 45c facing each other in the moving direction of the carriage 31 (the direction of arrow AA′ in FIG. 5). That is to say, the lifting and lowering mechanisms 50 are located so as to face each other at both ends in the width direction (that is, both upper and lower ends in FIG. 2) of the head housing 10 of the recording portion 9. The shafts 50b are provided so as to correspond to two sides of the rectangular support frame 40 extending in the direction perpendicular to the recording medium transport direction. The shafts 50b may be provided so as to correspond to two sides extending in the recording medium transport direction. In FIG. 8, the depiction of the lifting and lowering mechanism 50 on the side surface 45c side is omitted. A motor 47 and a drive transmission shaft 48 that transmits the rotational driving force of the motor 47 are attached to a side surface 45d of the unit housing 45 adjacent to the side surface 45b and 45c.

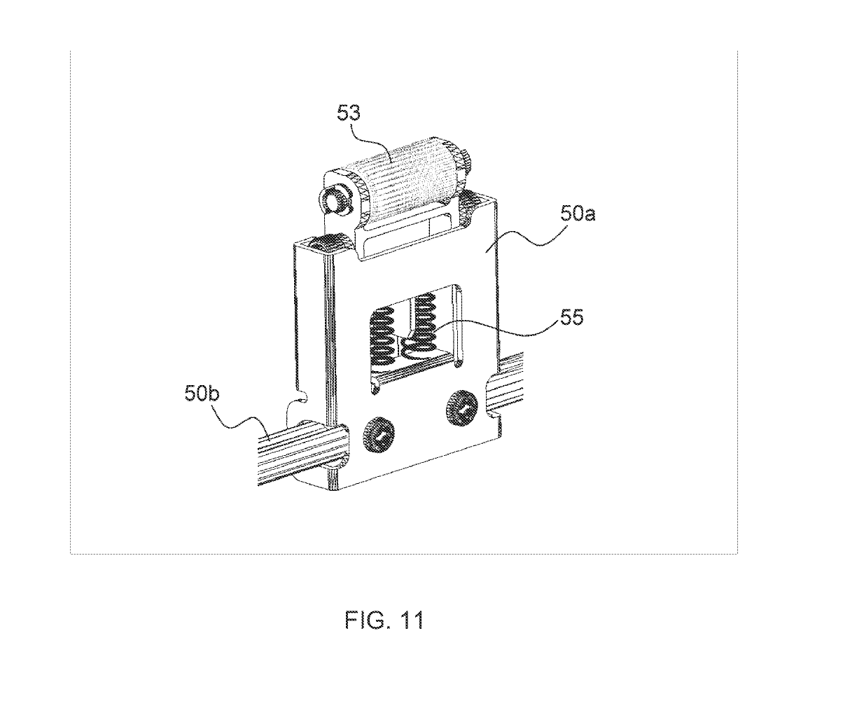

FIG. 11 is a perspective view of one of the lift members 50a including one of the lifting and lowering mechanisms 50. The lower end of the lift member 50a is fixed to the shaft 50b. A push-up roller 53 is rotatably attached to the upper end of the lift member 50a. The push-up roller 53 is engaged with an engaging portion 41c (see FIG. 5) formed at the lower end of the support frame 40 and can rotationally move along the engaging portion 41c. Therefore, the friction between the support frame 40 and the lift member 50a, when the lifting and lowering mechanisms 50 are operated, is reduced by the rotation of the push-up roller 53, and therefore the lifting and lowering operation can be smoothly performed. The push-up roller 53 may be urged by coil springs 55 away from the shaft 50b (upward in FIG. 11).

From the position illustrated in FIG. 9, the shaft 50b of the right lifting and lowering mechanism 50 is rotated in the clockwise direction, and the shaft 50b of the left lifting and lowering mechanism 50 is rotated in the counterclockwise direction. The lift members 50a laid down to the inside of the unit housing 45 stand up outwardly (in the directions of arrows B), and the push-up rollers 53 move to the outer ends of the engaging portions 41c. In this way, the lift members 50a are switched from the horizontal state to the upright state (the state illustrated in FIG. 10). Thus, the lift members 50a raise the carriage 31 together with the support frame 40.

From the position illustrated in FIG. 10, the shaft 50b of the right lifting and lowering mechanism 50 is rotated in the counterclockwise direction, and the shaft 50b of the left lifting and lowering mechanism 50 is rotated in the clockwise direction. The lift members 50a are laid down to the inside of the unit housing 45 (in the directions of arrows B′), and the push-up rollers 53 move to the inner ends of the engaging portions 41c. In this way, the lift members 50a are switched from the upright state to the horizontal state (the state illustrated in FIG. 9). Thus, the lift members 50a lower the carriage 31 together with the support frame 40.

Due to the above configuration, the lift members 50a lift and lower the plurality of wipers 35a to 35c by lifting and lowering the support frame 40. By switching the lift members 50a from the horizontal state to the upright state, the plurality of wipers 35a to 35c are raised and disposed in the wiping position. By switching the lift members 50a from the upright state to the horizontal state, the plurality of wipers 35a to 35c are lowered and disposed in the retracted position. The inclination angles of the lift members 50a may be equal to each other during the transition from the upright state to the horizontal state. The inclination angles of the lift members 50a during the transition may be, for example, the inclination angles to the bottom surface 45a of the unit housing 45.

For example, during the transition from the horizontal state shown in FIG. 9 to the upright state shown in FIG. 10, the inclination angle of the lift member 50a of the left lifting and lowering mechanism 50 in FIG. 10 in the counterclockwise direction with respect to the bottom surface 45a of the unit housing 45 and the inclination angle of the lift member 50a of the right lifting and lowering mechanism 50 in FIG. 10 in the clockwise direction with respect to the bottom surface 45a of the unit housing 45 may be equal to each other. During the transition from the upright state shown in FIG. 10 to the horizontal state shown in FIG. 9, the inclination angle of the left lifting and lowering mechanism 50 in FIG. 10 in the counterclockwise direction with respect to the bottom surface 45a of the unit housing 45 and the inclination angle of the right lifting and lowering mechanism 50 in FIG. 10 in the clockwise direction with respect to the bottom surface 45a of the unit housing 45 may be equal to each other.

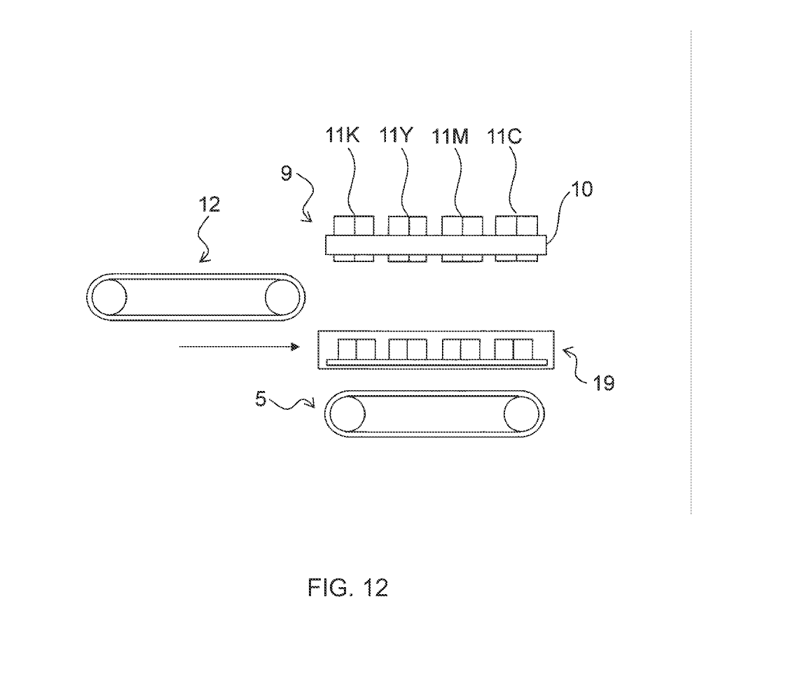

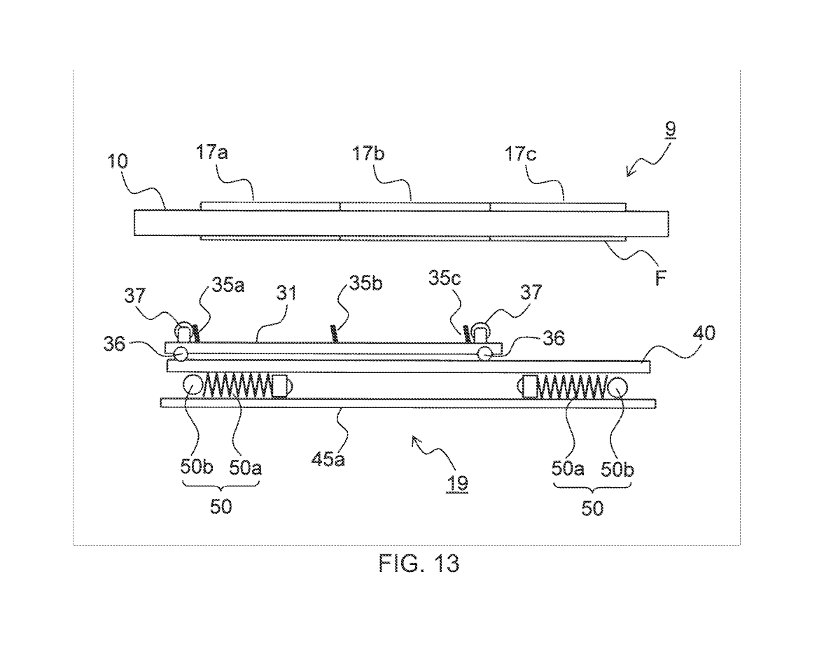

Next, the recovery of the recording heads 17a to 17c in the ink-jet recording apparatus 100 of this embodiment will be described. FIG. 12 is a side view showing the maintenance unit 19 positioned under the recording portion 9. FIG. 13 to FIG. 17 are side views showing the operation of the maintenance unit 19 during the wiping of the recording heads 17a to 17c. In FIG. 13 to FIG. 17, the support frame 40 is simplified like a plate. In FIG. 13 to FIG. 17, only the bottom surface 45a is depicted as the unit housing 45. FIG. 13 to FIG. 17 show the recording portion 9 and the maintenance unit 19 viewed from the downstream side in the sheet transport direction (the left side of FIG. 12).

When the recovery of the recording heads 17a to 17c is performed, first, as shown in FIG. 12, the first transport unit 5 located under the recording portion 9 is lowered. Then, the maintenance unit 19 located under the second transport unit 12 is moved horizontally and is disposed between the recording portion 9 and the first transport unit 5. In this position, as shown in FIG. 13, the lift members 50a of the lifting and lowering mechanisms 50 are in the horizontal state. The wipers 35a to 35c fixed to the carriage 31 are away from the ink ejection surfaces F of the recording heads 17a to 17c.

Before the wiping operation, in a state where printing is not performed by the recording heads 17a to 17c, the inflow valve 27 (see FIG. 4) is closed, and the syringe pump 21 (see FIG. 4) is pressed. The ink 22 in the cylinder 21a is supplied through the second supply path 25 to the recording heads 17a to 17c. The supplied ink 22 is forcibly ejected (purged) from the ink ejection nozzles 18. By this purge operation, thickened ink, foreign matter, and bubbles in the ink ejection nozzles 18 are discharged. Thus, the recording heads 17a to 17c can be recovered.

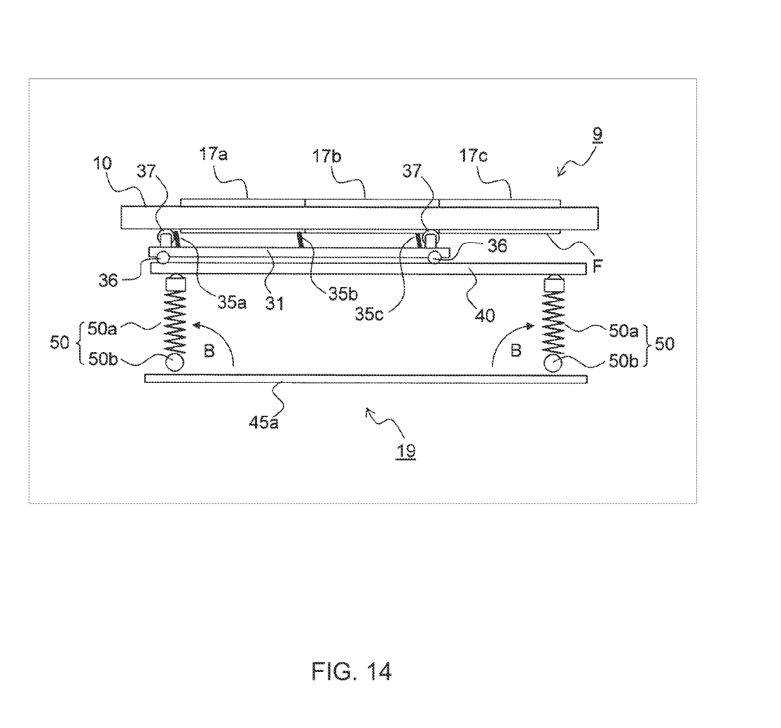

Next, the wiping operation, in which ink 22 ejected onto the ink ejection surfaces F is wiped, is performed. Specifically, as shown in FIG. 14, the shafts 50b of the lifting and lowering mechanisms 50 are rotated, and the lift members 50a are caused to stand up in the directions of arrows B. Thus, the lift members 50a lift the support frame 40 and the carriage 31. As shown in FIG. 14, the wipers 35a to 35c are pressed substantially perpendicularly against the wiping start positions of the ink ejection surfaces F (the left ends of the ink ejection surfaces F) of the recording heads 17a to 17c. At this time, the gap rollers 37 provided on the carriage 31 are pressed against the lower surface of the head housing 10 by the urging force of the coil springs 55 (see FIG. 11) of the lift members 50a. Therefore, the wipers 35a to 35c are pressed against the ink ejection surfaces F at a constant pressure.

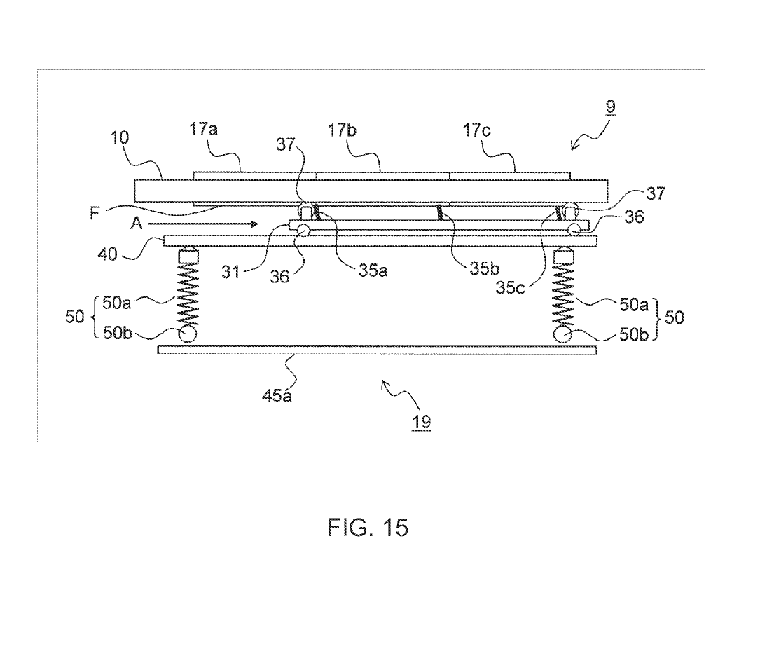

By rotating the input gear 43 (see FIG. 5) forward, as shown in FIG. 15, the carriage 31 is moved in the direction of arrow A. Thus, the wipers 35a to 35c wipe the ink ejected onto the ink ejection surfaces F of the recording heads 17a to 17c. At this time, an upward force is applied to the support frame 40 by the lifting and lowering mechanisms 50. Therefore, the carriage 31 moves in the direction of arrow A while maintaining a state where the gap rollers 37 are pressed against the head housing 10. The wasted ink wiped by the wipers 35a to 35c falls to the ink collecting tray 44 (see FIG. 7) and is collected.

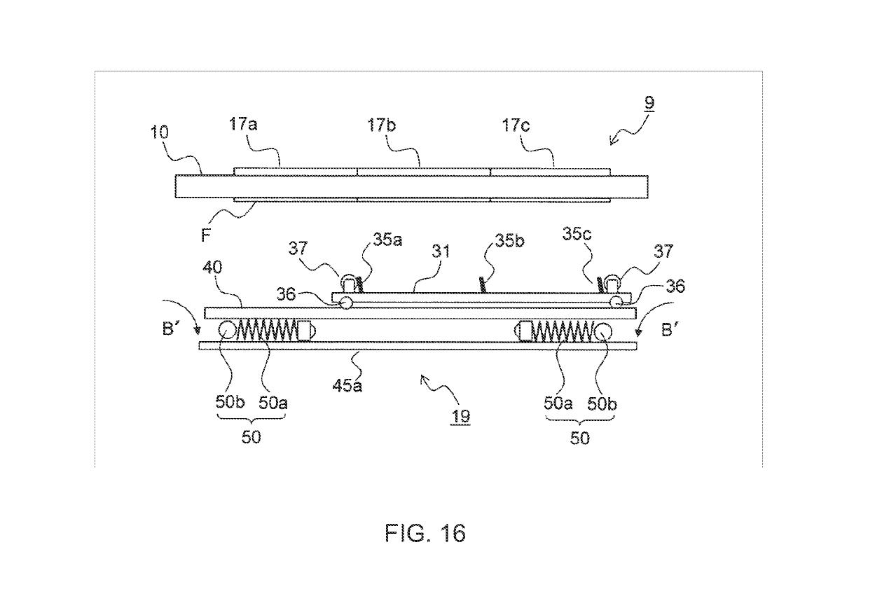

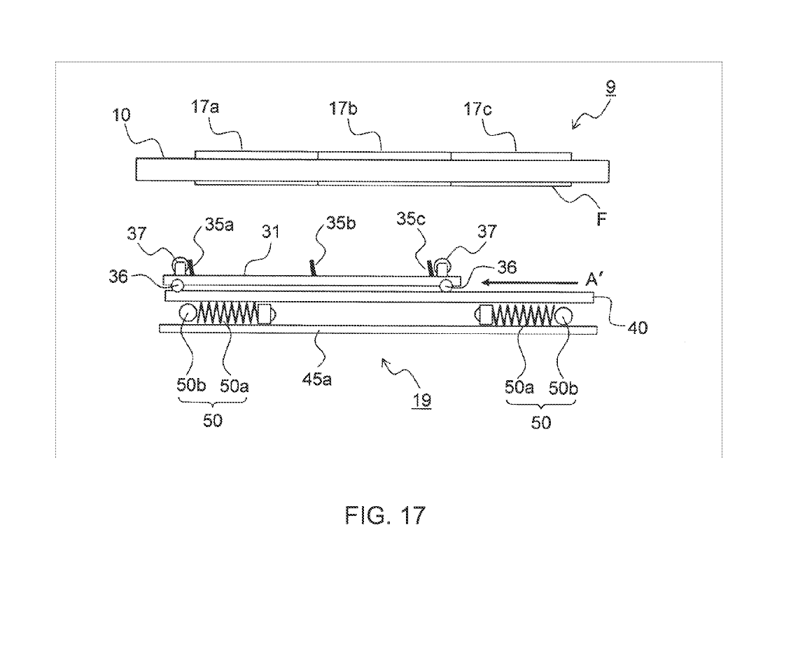

After the wipers 35a to 35c have moved to the downstream ends (the right ends in the example of FIG. 15) of the ink ejection surfaces F of the recording heads 17a to 17c, as shown in FIG. 16, the support frame 40 and the carriage 31 are lowered by rotating the shafts 50b of the lifting and lowering mechanisms 50 and thereby laying down the lift members 50a in the directions of arrows B′. Thus, the wipers 35a to 35c are retracted downward from the ink ejection surfaces F of the recording heads 17a to 17c. After that, the input gear 43 is rotated backward, the carriage 31 moves in me direction of arrow A′ as shown in FIG. 17, and the maintenance unit 19 returns to the state illustrated in FIG. 13.

As described above, in the configuration of this embodiment, three wipers 35a to 35c are fixed along the moving direction of the carriage 31 (the direction of arrow AA′). By the reciprocation of the carriage 31, and the lifting and lowering operation by the lifting and lowering mechanisms 50, the ink ejection surfaces F of the three recording heads 17a to 17c, included in the line heads 11C to 11K, can be wiped in a single operation.

To increase the printing width (printable region) of recording head, the line head corresponding to each color is composed of a plurality of recording heads. For example, when line heads corresponding to the four colors: cyan, magenta, yellow, and black are each composed of three recording heads, the total number of recording heads is 4×3=12, and 12 wipers are needed.

However, when one wiper is pressed against each recording head, and when each line head is composed of three recording heads, three holding members that hold wipers are provided. For this reason, a member or mechanism for adjusting the positional relationship between the wipers held by the three holding members and the recording heads is provided. Therefore, the number of parts increases, and the configuration becomes complex. When a plurality of holding members are lifted and lowered relative to the recording head, and when the plurality of holding members axe individually lifted and lowered, a plurality of lifting and lowering mechanisms are located at the boundaries between the recording heads. For this reason, ink is prone to adhere to the lifting and lowering mechanisms and may cause a malfunction.

As described above, the embodiment of the present disclosure provides an ink-jet recording apparatus in which even if the number of recording heads included in each line head is greater, the positional relationship between the recording heads and wipers can be maintained, and the wiping operation can be reliably performed, and that has a simple configuration, and a maintenance unit used therein.

In the ink-jet recording apparatus according to an embodiment of the present disclosure, when each line head provided in the recording portion is composed of a plurality of recording heads, the wiping of the ink ejection surfaces of the plurality of recording heads can be performed in a single operation by a plurality of wipers positioned so as to correspond to the recording heads. Therefore, the time required for the maintenance of the recording heads can be reduced, and the drive control during maintenance can be simplified. In addition, since the plurality of wipers are moved at the same time by reciprocating and lifting and lowering the carriage to which the plurality of wipers are fixed, the number of parts of the drive mechanism and lifting and lowering mechanism can be reduced.

As described with reference to FIG. 6, four wipers 35a are fixed to the second stay 33a so as to correspond to the four recording heads 17a on the left side as viewed from the downstream side in the sheet transport direction, four wipers 35b are fixed to the second stay 33b so as to correspond to the four recording heads 17b in the center as viewed from the downstream side in the sheet transport direction, and four wipers 35c are fixed to the second stay 33c so as to correspond to the four recording heads 17c on the right side as viewed from the downstream side in the sheet transport direction. For this reason, the wiping of a total of 12 recording heads constituting the line heads 11C to 11K by the above-described wipers 35a to 35c is performed in a single operation. Thus, the time required for the maintenance of the recording heads 17a to 17c is reduced. In addition, the drive control during maintenance can be simplified.

By pressing the gap rollers 37 provided on the carriage 31 against the head housing 10, a constant contact state between the wipers 35a to 35c and the ink ejection surfaces F of the recording heads 17a to 17c is maintained. Therefore, uneven wiping of ink due to a bad contact of the wipers 35a to 35c is reduced. In addition, the deformation and damage of the wipers 35a to 35c due to being excessively pressed is reduced. Furthermore, since the positions in the height direction of the wipers 35a to 35c need not be individually determined, the number of parts can be reduced.

Since the ink collecting tray 44 is positioned on the upper surface of the support frame 40, the ink collecting tray 44 is always located under the carriage 31. Therefore, the wasted ink wiped by the wipers 35a to 35c is reliably collected in the ink collecting tray 44. As a result, contamination in the unit housing 45 due to the spattering of wasted ink is reduced.

The present disclosure is not limited to the above embodiment, and various changes may be made therein without departing from the spirit of the present disclosure.

For example, instead of the mechanism for driving the carriage 31 composed of the rack 38 and the input gear 43, or the lifting and lowering mechanisms 50 composed of the lift members 50a and the shafts 50b, another drive mechanism can be used.

The number of the ink ejection nozzles 18 of the recording heads 17a to 17c, the nozzle spacing, and the like can be set according to the specifications of the ink-jet recording apparatus 100. The number of the recording heads is not particularly limited. For example, two or four or more recording heads can be disposed for each of the line heads 11C to 11K. In that case, the number and arrangement of wipers may be changed according to the number and arrangement of heads. When two or four or more recording heads are positioned for each of the line heads 11C to 11K, two or four or more wipers may be positioned.

Although 12 wipers are provided so as to correspond to 12 recording heads in the above embodiment, one wiper may be provided for each color. Alternatively, two wipers may be provided for each color. For example, one wiper may be used for the two recording heads 17a and 17c shown in FIG. 2, and another wiper may be used for the recording head 17b.

Although the wipers 35a to 35c move in the direction perpendicular to the recording medium transport direction in the above embodiment, wipers may move in the recording medium transport direction. In this case, wipers whose width in the direction perpendicular to the recording medium transport direction is equal to or larger than the width of the ink ejection surfaces of the recording heads in the direction perpendicular to the recording medium transport direction may be used.

The present disclosure can also be applied to a monochrome ink-jet recording apparatus having any one of the line heads 11C to 11K. In that case, one recording head 17a, one recording head 17b, and one recording head 17c are provided, and therefore one wiper 35a, one wiper 35b, and one wiper 35c corresponding to the recording heads 17a to 17c are fixed to the carriage 31.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent apparatuses and methods within the scope of the disclosure, in addition to those enumerated herein, will be apparent to those skilled in the art from the foregoing descriptions. Such modifications and variations are intended to fall within the scope of the appended claims. With respect to any or all of the ladder diagrams and flow charts in the drawings and as discussed herein, each block and/or communication may represent a process of information and/or a transmission of information in accordance with example embodiments and alternative embodiments may be included within the scope of such example embodiments. Further, more or fewer blocks and/or functions may be used with any of the ladder diagrams and flow charts discussed herein, and these ladder diagrams and flow charts may be combined with one another, in part or in whole.

The invention is claimed as follows:

1. An ink-jet recording apparatus comprising:
a recording medium transport mechanism;
a recording portion including one or more line heads that are arranged along a first direction in which the recording medium is transported and in each of which a plurality of recording heads are positioned in a second direction perpendicular to the first direction; and
a maintenance unit including a plurality of wipers positioned so as to correspond to the plurality of recording heads and configured to wipe ink ejection surfaces of the plurality of recording heads, a carriage to which the plurality of wipers are fixed, a support frame supporting the carriage such that the carriage can reciprocate, a drive mechanism configured to reciprocate the carriage along the support frame, and a lifting and lowering mechanism configured to lift and lower the support frame together with the carriage toward and away from the ink ejection surfaces, the maintenance unit being so constructed and arranged to wipe the ink ejection surfaces of the plurality of recording heads with the plurality of wipers by reciprocating and lifting and lowering the plurality of wipers.

2. The ink-jet recording apparatus according to claim 1,
wherein the recording portion includes a head housing that integrally holds the one or more line heads, and
the carriage is provided with a positioning member that contacts the head housing when the support frame approaches the ink ejection surfaces and maintains a predetermined distance between the plurality of wipers and the ink ejection surfaces.

3. The ink-jet recording apparatus according to claim 2,
wherein the positioning member is a rotationally driven body that can rotate in a direction in which the plurality of wipers move.

4. The ink-jet recording apparatus according to claim 1,
wherein the lifting and lowering mechanism includes a lift member configured to rotate in contact with a lower end of the support frame and to thereby be brought into an upright state and a horizontal state, and a shaft to which the lift member is fixed and that can rotate.

5. The ink-jet recording apparatus according to claim 4,
wherein the lifting and lowering mechanism includes a push-up roller that is rotatably supported at one end of the lift member and is urged away from the shaft by an urging member.

6. The ink-jet recording apparatus according to claim 4,
wherein the maintenance unit can be located in a maintenance position where the maintenance unit is close to the ink ejection surfaces of the plurality of recording heads and a retracted position where the maintenance unit is retracted from the ink ejection surfaces,
the plurality of wipers can be located in a wiping position where the plurality of wipers are close to the ink ejection surfaces and perform the wiping operation and an away position where the plurality of wipers are away from the ink ejection surfaces when the maintenance unit is disposed in the maintenance position,
the plurality of wipers are in the wiping position when the lift member is in the upright state, and
the plurality of wipers are in the retracted position when the lift member is in the horizontal state.

7. The ink-jet recording apparatus according to claim 1,
wherein the carriage reciprocates in the first direction.

8. The ink-jet recording apparatus according to claim 1,
wherein the carriage reciprocates in the second direction.

9. The ink-jet recording apparatus according to claim 1,
wherein the support frame has a rectangular shape having two sides extending in the first direction and two sides extending in the second direction,
the lifting and lowering mechanism includes a plurality of lift members configured to rotate in contact with a lower end of the support frame and to thereby be brought into an upright state and a horizontal state, and a plurality of shafts to which the plurality of lift members are fixed and that can rotate,
the plurality of shafts are located so as to correspond to the two sides extending in the first direction or the two sides extending in the second direction,
the plurality of lift members comprise two or more lift members positioned on each of the plurality of shafts, and
during the transition of the plurality of lift members between the upright state and the horizontal state, the inclination angles of the plurality of lift members are equal to each other.

10. The ink-jet recording apparatus according to claim 1, comprising an ink collecting tray that is located on the upper surface of the support frame and that collects ink wiped by the plurality of wipers.

11. A maintenance unit used in an ink-jet recording apparatus including a plurality of recording heads having ink election surfaces, the maintenance unit comprising:
a plurality of wipers positioned so as to correspond to the plurality of recording heads and configured to wipe ink ejection surfaces of the plurality of recording heads;
a carriage to which the plurality of wipers are fixed;
a support frame supporting the carriage such that the carriage can reciprocate;
a drive mechanism configured to reciprocate the carriage along the support frame; and
a lifting and lowering mechanism configured to lift and lower the support frame together with the carriage toward and away from the ink ejection surfaces,
wherein the maintenance unit is so constructed and arranged to wipe the ink ejection surfaces of the plurality of recording heads with the plurality of wipers by reciprocating and lifting and lowering the plurality of wipers.

12. The maintenance unit according to claim 11,
wherein the plurality of recording heads are held by a head housing, and
the carriage is provided with a positioning member that contacts the head housing when the support frame approaches the ink ejection surfaces and maintains a predetermined distance between the plurality of wipers and the ink ejection surfaces.

13. The maintenance unit according to claim 12,
wherein the positioning member is a rotationally driven body that can rotate in a direction in which the plurality of wipers move.

14. The maintenance unit according to claim 11,
wherein the lifting and lowering mechanism includes a lift member configured to rotate in contact with a lower end of the support frame and to thereby be brought into an upright state and a horizontal state, and a shaft to which the lift member is fixed and that can rotate.

15. The maintenance unit according to claim 14,
wherein the lifting and lowering mechanism includes a push-up roller that is rotatably supported at one end of the lift member and is urged away from the shaft by an urging member.

16. The maintenance unit according to claim 14,
wherein the maintenance unit can be located in a maintenance position where the maintenance unit is close to the ink ejection surfaces of the plurality of recording heads and a retracted position where the maintenance unit is retracted from the ink ejection surfaces,
the plurality of wipers can be located in a wiping position where the plurality of wipers are close to the ink ejection surfaces and perform the wiping operation and an away position where the plurality of wipers are away from the ink ejection surfaces when the maintenance unit is disposed in the maintenance position,
the plurality of wipers are in the wiping position when the lift member is in the upright state, and
the plurality of wipers are in the retracted position when the lift member is in the horizontal state.

17. The maintenance unit according to claim 11,
wherein the carriage reciprocates in a first direction in which a recording medium onto which the plurality of recording heads eject ink is transported.

18. The maintenance unit according to claim 11,
wherein the carriage reciprocates in a second direction perpendicular to a first direction in which a recording medium onto which the plurality of recording heads eject ink is transported.

19. The maintenance unit according to claim 11,
wherein the support frame has a rectangular shape having two sides extending in a first direction in which a recording medium onto which the plurality of recording heads eject ink is transported and two sides extending in a second direction perpendicular to the first direction,
the lifting and lowering mechanism includes a plurality of lift members configured to rotate in contact with a lower end of the support frame and to thereby be brought into an upright state and a horizontal state, and a plurality of shafts to which the plurality of lift members are fixed and that can rotate,
the plurality of shafts are located so as to correspond to the two sides extending in the first direction or the two sides extending in the second direction,
the plurality of lift members comprise two or more lift members positioned on each of the plurality of shafts, and
during the transition of the plurality of lift members between the upright state and the horizontal state, the inclination angles of the plurality of lift members are equal to each other.

20. The maintenance unit according to claim 11, comprising an ink collecting tray that is located on the upper surface of the support frame and that collects ink wiped by the plurality of wipers.
